(19) United States
(12) Patent Application Publication
(10) Pub. No.: US 2023/0093313 A1
(43) Pub. Date: Mar. 23, 2023

(54) Imaging System with Multi-Stop Aperture

(71) Applicant: Apple Inc., Cupertino, CA (US)

(72) Inventor: Erik J. Bjornard, San Jose, CA (US)

(21) Appl. No.: 17/940,914

(22) Filed: Sep. 8, 2022

Related U.S. Application Data
(60) Provisional application No. 63/247,115, filed on Sep. 22, 2021.

(51) Int. Cl. G02F 1/155; G02F 1/163; G03B 17/12

(52) U.S. Cl. CPC G02F 1/155; G02F 1/163; G03B 17/12; G02F 2001/1557; G02F 2001/1555

(57) ABSTRACT

An imaging system for a portable electronic device includes a variable aperture between a lens group and an image sensor. The variable aperture is defined by an electrochromic stack that defines at least two switching regions and a central non-switching region. The switching regions can be defined by concentric ring electrodes disposed below an electrochromic stack including a counter electrode, an ion conductor layer, and an electrochromic material. Above the electrochromic stack is disposed a shared electrode. The shared electrode and the concentric ring electrodes can be formed from indium tin oxide. By applying at least a threshold voltage to one or more of the concentric ring electrodes, an electric field can be generated by each driven electrode and a respective portion of the shared electrode, inducing a transition from a bleached state to a colored state in a respective portion of the electrochromic stack.

### CROSS-REFERENCE TO RELATED APPLICATION(S)

This application is a nonprovisional of, and claims the benefit under 35 U.S.C. § 119 of, U.S. Provisional Patent Application No. 63/247,115, filed on Sep. 22, 2021, and entitled “IMAGING SYSTEM WITH MULTI-STOP APERTURE,” the contents of which are incorporated by reference in their entirety.

### TECHNICAL FIELD

Embodiments described herein relate to imaging systems for portable electronic devices and, in particular, to imaging systems incorporating an electrically-controllable aperture layer positioned above an image sensor of an imaging system of a portable electronic device.

### BACKGROUND

An electronic device may include an imaging system for capturing an image of a scene. A conventional imaging system includes an image sensor aligned with a focal plane defined by a configuration of lens elements, referred to as a lens group. The imaging system can also include an aperture positioned between the lens group and the image sensor that limits light exposed to the image sensor.

Certain electronic devices, such as portable electronic devices, are often designed specifically to minimize device profile. As a result, portable electronic devices incorporating imaging systems typically include a fixed aperture, which may not be optimally sized for all scenes.

### SUMMARY

Embodiments described herein relate to multi-stop electrochromic apertures for imaging systems of an electronic device, such as a portable electronic device. Embodiments include at least one inner switching region and at least one outer switching region each concentrically circumscribing a central non-switching region. The inner switching region can be defined, at least in part, by a ring electrode disposed over a dielectric material. The ring electrode circumscribes the central non-switching region.

The outer switching region can be defined at least in part by a second ring electrode co-planarly disposed with the first ring electrode and circumscribing the first ring electrode. Both the first and second ring electrodes can be formed form indium tin oxide, or another suitable optically transparent and electrically conductive material.

The first and second ring electrodes are disposed below an electrochromic stack that includes a counter electrode, an ion conducting layer, and an electrochromic layer.

Above the electrochromic layer can be disposed a single shared electrode. As a result of this construction, a voltage applied to the first ring electrode can cause the inner switching region to transition from a bleached state to a colored state (or vice versa, in some constructions). Similarly, a voltage applied to the second ring electrode can cause the outer switching region to transition from a bleached state to a colored state.

In these embodiments, a minimum aperture may be defined when each of the inner switching region and the outer switching region are colored (e.g., when the first ring electrode and the second ring electrode are each energized with a voltage, which may be the same voltage or a different voltage). In other words, because each of the inner switching region and the outer switching region are colored, light may pass substantially only through the central non-switching region.

If voltage is not applied (or an opposing voltage is applied) to the first ring electrode, the inner switching region can transition the inner switching region from the colored state to a bleached state, thereby increasing the effective aperture of the multi-stop electrochromic aperture. In other words, because only the outer switching region is colored, light may pass substantially only through the central non-switching region and the (bleached) inner switching region.

If voltage is not applied (or an opposing voltage is applied) to the second ring electrode, the outer switching region can transition the outer switching region from the colored state to a bleached state, thereby increasing the effective aperture of the multi-stop electrochromic aperture further still. In other words, because neither the inner switching region nor the outer switching region is colored, light may pass through each of the central non-switching region, the (bleached) inner switching region, and the (bleached) outer switching region.

In still further embodiments, a sheet resistance of the first ring electrode can be selected (e.g., via ion doping, thickness variation so that voltage drop between different portions of the first ring electrode and the shared electrode can progressively change, which in turn may progressively change effective transmittance of the electrochromic stack. In these examples, the inner switching region may have transparency that varies by radius, thereby resulting in a Gaussian or super-Gaussian aperture.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A depicts an example electronic device that can include an imaging system and/or imaging system component, such as described herein.

FIG. 1B depicts the example electronic device of FIG. 1A, showing an imaging system, such as described herein.

FIG. 2 is a simplified system diagram of an electronic device as described herein.

FIG. 3 depicts an imaging system component in cross-section that may be used with an imaging system incorporated into an electronic device, such as described herein.

FIGS. 4A-4F each depict an imaging system component, such as shown in FIG. 3, depicting switching regions in various modes of operation (e.g., bleached or colored).

FIG. 5A depicts a cross-section of a multi-stop controllable aperture as described herein, in which a first and second switchable region of the multi-stop aperture are operated in a bleached state.

FIG. 5B depicts a top view of the multi-stop controllable aperture of FIG. 5A.

FIG. 5C depicts a cross-section of a multi-stop controllable aperture as described herein, in which a first switchable region of the multi-stop aperture is operated in a bleached state and a second switchable region of the multi-stop aperture is operated in a colored state.

FIG. 5D depicts a top view of the multi-stop controllable aperture of FIG. 5C.

FIG. 5E depicts a cross-section of a multi-stop controllable aperture as described herein, in which a first and second switchable region of the multi-stop aperture is operated in a colored state.

FIG. 5F depicts a top view of the multi-stop controllable aperture of FIG. 5E.

FIG. 5G depicts a cross-section of a multi-stop controllable aperture as described herein, in which a first switchable region of the multi-stop aperture is operated in a graduated bleached state and a second switchable region of the multi-stop aperture is operated in a colored state.

FIG. 5H depicts a top view of the multi-stop controllable aperture of FIG. 5G.

FIG. 6 is a flowchart depicting example operations of a method of operating an imaging system component, such as described herein.

FIG. 7 is a flowchart depicting example operations of a method of operating an imaging system component, such as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Similarly, certain accompanying figures include vectors, rays, traces and/or other visual representations of one or more example paths—which may include reflections, refractions, diffractions, and so on, through one or more mediums—that may be taken by, or may be presented to represent, one or more photons, wavelets, or other propagating electromagnetic energy originating from, or generated by, one or more light sources shown or, or in some cases, omitted from, the accompanying figures. It is understood that these simplified visual representations of light or, more generally, electromagnetic energy, regardless of spectrum (e.g., ultraviolet, visible light, infrared, and so on), are provided merely to facilitate an understanding of the various embodiments described herein and, accordingly, may not necessarily be presented or illustrated to scale or with angular precision or accuracy, and, as such, are not intended to indicate any preference or requirement for an illustrated embodiment to receive, emit, reflect, refract, focus, and/or diffract light at any particular illustrated angle, orientation, polarization, color, or direction, to the exclusion of other embodiments described or referenced herein.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to electronically-controllable apertures (or, more simply, a “switchable aperture”) with uniform or substantially uniform index of refraction and optical path length through and between both switching areas and non-switching areas, thereby among other benefits and improvements substantially mitigating phase distortion effects presented by conventional switching apertures.

More particularly, embodiments described herein define an electronically controllable aperture having multiple concentrically aligned and individually controllable, switchable regions. These regions are, in many constructions, formed in the same layer and as a result, additional switchable regions do not substantively increase stack height or light absorption when a switchable region is operated in a bleached state. In a more simple phrasing, embodiments described herein can be leveraged to implement an electronically-controllable aperture with any suitable number of stops without substantively impacting quality of an image captured through the electronically-controllable aperture.

An electronically-controllable aperture or switchable aperture as described herein may in some implementations be configured for use with a camera module (which may also be referred to herein as an “imaging system”) of a portable electronic device, such as a cellular phone, a wearable device, a tablet device, a laptop device, a personal heads-up display device, a video conferencing device, and so on.

In particular, a switchable aperture as described herein can be manufactured such that light passing through the switchable aperture encounters substantially the same overall change in index of refraction along its path (a length of which is consistent regardless of incident angle), regardless whether that path intersects a switching region of the switchable aperture or that path intersects a non-switching region of the switchable aperture. As a result of constructions described herein, the switchable aperture exhibits substantially reduced visible light absorption (e.g., a stack exhibits high transparency) compared to conventional designs.

As a result of constructions and manufacturing techniques described herein, a switchable aperture, or other similarly-configured or operated imaging system component, can minimize imaging artifacts, such as (and with particular reference to) phase distortion, that may be imparted by conventional switchable apertures and other conventional switchable or controllable imaging system components.

In particular, many embodiments described herein include an electrochromic stack disposed onto, and/or formed onto, an optically transparent substrate, which may be formed from a material such as a silica glass.

The electrochromic stack includes a counter-electrode layer, which can be lithiated to store lithium ions, an ion conductor layer disposed over the counter-electrode to conduct lithium ions from the counter-electrode in the presence of an electric field (e.g., by application of voltage across the electrochromic stack), and an electrochromic material disposed over the ion conductor layer.

The electrochromic material can include any suitable organic or inorganic monolith material or combination of materials (e.g., mixture, amalgam, suspension, multilayer, and so on), including transition metal oxides such as tungsten oxide, molybdenum oxide, iridium oxide, nickel oxide, vanadium oxide, and other metal oxides and alloys thereof. In other cases, organic compounds may be used additionally or in place of a transition metal oxide.

For embodiments described herein, as noted above, an electrochromic material can be positioned on, and/or disposed on, an ion conductor layer that facilitates transfer of ions (e.g., lithium ions) to, or from, the electrochromic material, thereby electrochemically inducing an oxidation-reduction in the electrochromic material that in turn changes one or more optical properties of that material, such as transmittance (in a particular band or set of bands of visible or nonvisible light) and/or reflectance (in a particular band or set of bands of visible or nonvisible light).

The electrochromic stack can be disposed between and/or formed between two electrically conductive and optically transparent layers that are conductively decoupled from one another. The optically transparent conductive layers may be formed from a transparent electrically conductive material such as a metal oxide (e.g., indium tin oxide, as one example). In other cases, the optically transparent conductive layers may be formed from a metal nanowire dispersion. Each of the conductive layers can in turn be conductively coupled to at least a respective one electrode, which may be formed from metal. In some cases, an electrode can be at least partially defined as a via through the optically transparent substrate.

As a result of this construction, applying a voltage across the two electrodes generates an electric field between the two optically transparent conductive layers which, in turn, motivates ion transfer to, or from, the electrochromic layer through the ion conductor layer. This change in ion concentration (e.g., charge concentration), as noted above, can result in an oxidation-reduction reaction that affects transmittance (e.g., opacity) and/or reflectance (e.g., color) of the electrochromic stack.

For simplicity of description, the embodiments that follow reference an electrochromic stack configured to change transmittance in the visible spectrum, although it is appreciated that this is merely one example and other electrochromic stacks and other imaging system components can be configured in other ways.

For embodiments described here, one or both of the optically transparent conductive layers can be patterned in a concentric manner to define one or more conductively decoupled concentric electrodes referred to herein as ring electrodes.

For example, in one embodiment, a central region of an electronically-controllable aperture can be formed from a dielectric/non-conducting material. The central region may be a non-switching region. More particularly, the central/non-switching region may not overlap with an electrochromic stack, such as described above.

Surrounding or circumscribing a perimeter of the central region can be a first ring electrode, also referred to herein as an “inner” electrode. Surrounding or circumscribing a perimeter of the first ring electrode can be a second ring electrode, also referred to herein as an “outer” electrode. In some cases, further subsequent ring electrodes can be disposed to circumscribe the second and first ring electrodes. For simplicity of description, the embodiments that follow reference a pair of concentric ring electrodes, referred to as a first and second ring electrodes and/or the inner ring electrode and the outer ring electrode.

In these embodiments, the first and second ring electrodes can be conductively decoupled from one another. In other words, a dielectric can separate the first and second ring electrodes. The first and second ring electrodes can be disposed within the same layer of the electronically-controllable aperture.

In many cases, the first ring electrode can be electrically coupled to control circuitry via a conductive trace that extends below the second ring electrode. The conductive trace may be a nanowire, an electrical via, or any other suitable conductive coupling. In other cases, multiple conductive traces, angularly distributed across different regions of (e.g., above, below or through) the second ring electrode, may be used.

In other embodiments, the first ring electrode can be conductively coupled to control circuitry via a third ring electrode that is positioned below the second ring electrode. The third ring electrode can extend from an edge region or perimeter region of the electronically-controllable aperture, below the second ring electrode, and may conductively couple to the first ring electrode via a vertical conductive coupling, thereby forming a stair-stop geometry in cross section. In this manner, when the third ring electrode is provided with a voltage, the first ring electrode may also be driven to the same voltage.

The first and second ring electrodes can be disposed below an electrochromic layer, which as noted above, can include a counter electrode, an ion conducting layer, and an electrochromic layer. Above the electrochromic stack can be a shared electrode that extends over the first ring electrode, the second ring electrode, and (optionally) the central region.

As a result of this construction, when the second ring electrode is driven to a particular (implementation-specific) voltage, an electric field can be generated only between the second ring electrode and the shared electrode. Similarly, when the third ring electrode (and, correspondingly the first ring electrode) is driven to a particular (implementation-specific) voltage, an electric field can be generated between the first ring electrode and the shared electrode.

As noted above, in the presence of an electric field, the electrochromic stack may transition from a bleached (substantially transparent, e.g., 90%) state to a colored state (substantially opaque, e.g., 5%). In view of this, when the second ring electrode is driven to a particular (implementation-specific) voltage, an electric field can be generated only between the second ring electrode and the shared electrode thereby transitioning a portion of the electrochromic stack between the shared electrode and the second ring electrode from a bleached state to a colored state.

Similarly, when the third ring electrode (and, correspondingly the first ring electrode) is driven to a particular (implementation-specific) voltage, an electric field can be generated between the first ring electrode and the shared electrode thereby transitioning a portion of the electrochromic stack between the shared electrode and the second ring electrode from a bleached state to a colored state.

In this manner, more generally and broadly, by selectively controlling voltage applied to the first ring electrode and/or the second ring electrode, an effective transparent diameter of the electronically-controllable aperture can be set.

In some examples, the first/inner ring electrode can be disposed so as to exhibit a particular sheet resistance. For example, the first/inner electrode may be implanted with ions such as argon, germanium, phosphorous, zirconium, or strontium which, in turn, may change conductivity of (or, phrased in another manner, sheet resistance of) the first/inner ring electrode.

In this manner, the first/inner ring electrode may be electrically represented as a resistor across its radius, in turn exhibiting a voltage drop across its radius. In other words, when a voltage is applied to the first/inner ring electrode, an electric field generated between the first/inner ring electrode and the shared electrode may vary change across the radius of the first/inner ring electrode. In turn, as noted above, transparency/opacity of the electrochromic stack between the first/inner ring electrode and the shared electrode may gradually change across the radius of the first/inner ring electrode.

As a result of the foregoing-described architecture, in some cases, an electronically-controllable aperture as described herein may not necessarily have binary transparency/opacity in switching regions. In some cases, such as described above, transparency may radially vary. In another phrasing, an electronically-controllable aperture can be operated as a gaussian or super-gaussian aperture and/or may be operated as a binary aperture. Many configurations and constructions, along with corresponding control circuitry and methodologies, can be implemented in view of the embodiments described herein.

In this manner, voltage applied to the electrochromic stack controls a size of a light-transmissible area of the electrochromic stack. More broadly, the electrochromic stack defines a multi-stop aperture that can be used with an imaging system; voltage controls an effective radius (or stop) of a transparent portion of the electrochromic stack.

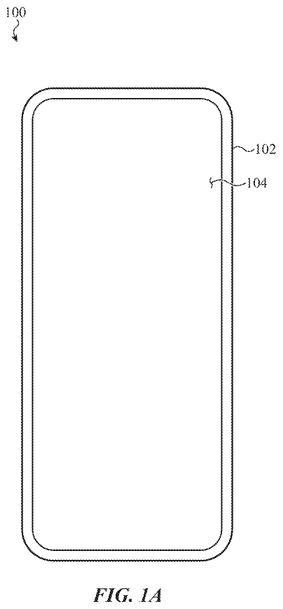

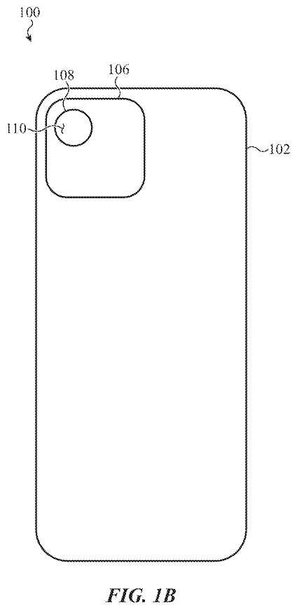

These foregoing and other embodiments are discussed below with reference to FIGS. 1A-7. However, those skilled in the art will readily appreciate that the detailed description given herein with respect to these figures is for explanation only and should not be construed as limiting.

FIG. 1A depicts an example electronic device that can include an imaging system and/or imaging system component, such as described herein. The electronic device 100 may be a portable electronic device, such as a cellular phone, wearable device, or tablet computing device. It may be appreciated, however, that a portable electronic device is merely one example device that can include an imaging system and/or imaging system component as described herein.

The electronic device 100 as depicted in FIG. 1A is defined at least in part by a low-profile (e.g., thin) housing, identified in the figure as the housing 102. The housing 102 can enclose and support one or more components of the electronic device 100, such as a processor, one or more memory components or circuits, a battery, and a display 104.

For simplicity of description and illustration, FIG. 1A is depicted without many of these components; a person of skill in the art may readily appreciate that a number of components, circuits, structures, and systems can be included in the housing 102 of the electronic device 100. For example, the electronic device 100 can include a processor configured to access a memory to instantiate a software application configured to render a graphical user interface via the display 104.

The software application can, in some examples, be configured to integrate with one or more hardware sensors or sensing systems of the electronic device 100, such as an imaging system. FIG. 1B depicts the example electronic device of FIG. 1A, showing an imaging system 106. The imaging system 106 can include a camera module 108 that includes a set of imaging system components 110.

In particular, the imaging system 106 can include an image sensor disposed at an image plane defined by a lens group of the set of imaging system components 110. The lens group may define a fixed or variable focal length.

The set of imaging system components 110 can also include a variable or multi-stop aperture as described herein. The multi-stop aperture can be positioned between the lens group and the image sensor so as to control a quantity of light received by the image sensor. As known to a person of skill in the art, the multi-stop aperture can offer control over image brightness and depth of field.

In many examples, the multi-stop aperture can include an electrochromic stack, as described herein. In particular, the multi-stop aperture may be defined, at least in part, by an electrochromic stack that defines at least two switchable regions and, in many examples, a non-switching region. In some cases, a non-switching region may not be required; in such examples, the multi-stop aperture may also function as a shutter or neutral density filter, transitioning and holding at any stage between from fully opaque (or substantially opaque) to at least partially transparent.

The non-switching region of the electrochromic stack of the multi-stop aperture can be positioned generally in a geometric center of the multi-stop aperture. In many examples, the non-switching region takes a circular shape, although this is not required of all embodiments and other shapes may be possible or preferred. In typical examples, the non-switching region is aligned with an imaging axis of the lens group and the image sensor.

The non-switching region of the electrochromic stack of the multi-stop aperture is circumscribed by a switching region. As noted with respect to other embodiments described herein, the switching region can toggle between transparent and opaque in response to an application of appropriate, implementation-specific, voltage (e.g., at least a threshold voltage of a particular polarity). In some cases, application of voltage induces a transition from transparent to opaque. In other cases, application voltage induces a transition from opaque to transparent.

In this manner, when the switching region circumscribing the non-switching region is opaque, the effective diameter of the multi-stop aperture is defined by a diameter of the non-switching region. Alternatively, when the switching region is transparent (or substantially transparent), the effective diameter is larger and is defined by a diameter or area of the switching region.

In some embodiments, as noted above, the switching region can be segmented into concentrically-aligned switchable regions so that multiple discrete aperture diameters can be selectively activated. For simplicity of description, the embodiments described herein focus to implementations with two switching regions; it is appreciated that this is merely one example and other embodiments may be implemented differently.

The switching regions of the electrochromic stack of the multi-stop aperture can be independently conductively coupled to a controller, which may be referred to as an aperture controller. The aperture controller can include a switchable voltage source that can be selectively applied to the switching region to change the transmissivity (alternatively phrased, opacity) thereof. In some embodiments, the aperture controller can be configured to apply a “transition” voltage which may be different form a “maintain” voltage. The transition voltage may be applied to induce a shift from a bleached state to a colored state (or vice versal). The maintain voltage may be less than the transition voltage and may be used to maintain a colored (or bleached) state for a particular period of time.

In many cases, the aperture controller is communicably coupled to one or more instances of software executing over a processor disposed within the housing 102 of the electronic device 100. For example, in some embodiments, a software application instance instantiated over a processor and/or memory of the electronic device 100 can leverage the display 104 to generate a user interface with which a user of the electronic device 100 can interact. In some examples, the software application may be an imaging application, such as a camera control application.

The camera control application can present one or more user interface elements via the display 104 which may be selected by a user. In some cases, one of the user interface elements can be used by a user of the electronic device 100 to control a size of the aperture. In other words, in some cases, the user interface may receive a signal or other input from a user comprising an instruction to change a size of the aperture of the camera module 108. In response to the signal received via the user interface, the aperture controller can apply a voltage to at least one switching region of the electrochromic stack to change a transmissivity of that region, thereby changing an effective diameter of the multi-stop aperture of the imaging system 106. In some embodiments, the camera control application can automatically control the operation of the aperture controller, based on one or more automatically determined characteristics of a scene within a field of view of the imaging system. For example, the camera control application (and/or another controller, whether implemented in whole or in part in software or hardware) can cause the aperture controller to reduce the radius of the multi-stop aperture (e.g., by transitioning additionally smaller switching regions to a colored state.

These foregoing embodiments depicted in FIGS. 1A-1B and the various alternatives thereof and variations thereto are presented, generally, for purposes of explanation, and to facilitate an understanding of various configurations and constructions of a portable electronic device that can incorporate an imaging system that includes a variable aperture, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

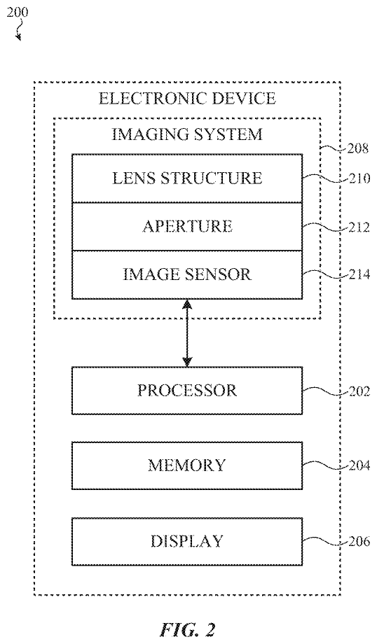

For example, more generally and broadly, it may be appreciated that any suitable electronic device can include an imaging system as described herein. FIG. 2 is a simplified system diagram of such an example electronic device that can include an imaging system, as described herein.

For example, an electronic device that can include an imaging system and/or imaging system component as described herein can be implemented as an example electronic device, identified in FIG. 2 as the electronic device 200.

The electronic device 200 can include a processor 202, a memory 204, and (optionally) a display 206. As noted with respect to other embodiments described herein, the processor 202 can be configured to access the memory 204 to retrieve one or more computer-executable instructions and/or other executable assets in order to instantiate one or more instances of software that, in turn, may perform or coordinate one or more operations performed by the processor 202.

For example, in some embodiments, the electronic device 200 can leverage the processor 202 and the memory 204 to instantiate an instance of a photography software application. The photography software application instance can be configured to access and/or communicably couple to an imaging system 208 of the electronic device 200.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Similarly, the term “memory” refers to any software and/or hardware-implemented data processing device or circuit physically and/or structurally configured to define a temporary or durable (e.g., volatile or nonvolatile) storage media configured to store one or more data structures or files and so on, regardless of media type (e.g., optical, magnetic, electric, photonic, and so on).

The imaging system 208 can include a lens structure 210, a multi-stop aperture 212, and an image sensor 214. The lens structure 210 can be configured to receive and focus light from a scene external to the electronic device 200 that may be imaged by the image sensor 214. The lens structure 210 can include any suitable number of optical elements configured to modify a phase or direction of light passing through. The lens structure 210 can include one or more movable or fixed concave or convex lenses; the configuration and/or position of the lenses of the lens structure 210 can vary from embodiment to embodiment.

In some cases, the lens structure 210 can also include one or more filters configured to exhibit selected reflectance and/or transmittance for particular bands of light. For example, the lens structure 210 can include an infrared cut filter configured to reflect infrared light away from the image sensor 214.

In other cases, an infrared cut filter may be configured to absorb infrared light. In yet other cases, the lens structure 210 can include one or more color filters configured to reflect particular colors of light. In yet other cases, the lens structure 210 can include one or more reflective surfaces, such as mirrors or beam splitters configured to redirect a path of light as it passes through the lens structure 210. For example, in some constructions the imaging system 208 can be implemented with a periscopic lens structure.

These forgoing examples are not exhaustive of the types or arrangements of optical elements that can be leveraged by an imaging system, such as described herein. In particular, it may be appreciated by a person of skill in the art that the lens structure 210 can include any number of suitable optical elements, arranged in any suitable order, for any particular embodiment.

The imaging system 208 also includes a multi-stop aperture 212 positioned between the lens structure 210 and the image sensor 214. The multi-stop aperture 212 is configured to selectably control a quantity of light exposed to the image sensor 214. Control of the multi-stop aperture 212 may be automatic (e.g., software or hardware controlled based, in one example, at least in part on an exposure setting of the imaging system 208).

More specifically, as noted with respect to other embodiments described herein, the multi-stop aperture 212 defines a switchable opaque area circumscribing a non-switchable transparent area. The transparent area is defined in a center of the multi-stop aperture 212 and exhibits substantially the same index of refraction as the switchable opaque area that circumscribes the transparent area.

For example, in some constructions the transparent area of the multi-stop aperture 212 is formed from a non-active/deactivated portion of an electrochromic stack. An active portion of the same electrochromic stack can circumscribe the non-active portion. In this construction the entire multi-stop aperture is formed from the same layers of material, and thus exhibits substantially the same index of refraction across its area, regardless whether light passes through the non-active portion of the electrochromic stack (e.g., a non-switched, transparent, central region) or whether light passes through the active portion of the electrochromic stack.

An electrochromic stack including an active portion circumscribing a non-active portion can be manufactured in a number of suitable ways. In some embodiments, a sheet of electrochromic material (e.g., a sheet defining a single, active area) includes two transparent conductive sheets disposed on opposite surfaces of an ion conductor layer and an electrochromic material. In these examples, one or both of the conductive sheets can be etched via laser or chemical processes to conductively decouple one portion of the sheet from another. For example, a laser may be used to define a non-switching region from a switching region by tracing out a circular pattern following a perimeter of a desired shape of the non-switching region. In another example, an etch process may be used to conductively decouple the switching region from the non-switching region.

In these examples, a channel that separates the switching region from the non-switching region can introduce phase distortion or other undesirable effects. More specifically, light that passes through the channel encounters a different index of refraction than light that passes through the switching region or the non-switching region. More specifically, light that passes through either the switching region or the non-switching region first encounters a transparent conductive sheet whereas light that passes through the channel first encounters either an electrochromic material or an ion conductor layer. As a result of this difference, phase of light that reaches the image sensor 214 may be different depending on whether that light passed through the channel of the multi-stop aperture 212 or a switching or non-switching region of the multi-stop aperture 212.

To account for, and mitigate, phase distortion and other undesirable optical effects, the channel can be backfilled as described above with a dielectric material that approximates, and/or is equal to, an index of refraction of the transparent conductive layer through which the channel is defined. For example, in some embodiments, the transparent conductive layer may be formed from indium-tin oxide, which may have an index of refraction of 1.9-2.0. In this example, the channel may be backfilled with niobium oxide, zirconium oxide, silicon nitride, or mixtures thereof to define a dielectric backfill material having an index of refraction approximately equivalent to 1.9-2.0. In other examples, a material having an index of refraction as close to 1.9-2.0 as possible may be selected; custom dielectric materials may be suitably designed and used to approximate an index of refraction of the conductive layer. In some cases, the dielectric may be a solid material, such as a cured adhesive or polymer material. In other cases, a liquid dielectric may be used. In still other cases, the channel may be backfilled with a gas having an index of refraction equal to and/or approximating an index of refraction of the conductive layer. In these examples, the multi-stop aperture 212 may be hermetically sealed to prevent gaseous or liquid backfill materials from escaping.

As a result of the foregoing described implementation, light that passes through the multi-stop aperture 212 may encounter substantially the same index of refraction, regardless of whether that light passes through the non-switching region, the switching region, or the channel region separating the switching region from the non-switching region.

In other configurations, a non-switching region of the multi-stop aperture 212 can be formed by etching through an entire electrochromic stack (e.g., not just the outermost transparent conductive layers). In these examples, a cavity taking the shape of a non-switching layer can be defined by etching through the entire stack. As with other embodiments described herein, the cavity can be filled with a material that approximates the index(es) of refraction of light passing through other portions of the multi-stop aperture 212.

These foregoing examples are not exhaustive; it may be appreciated that any number of suitable optically transparent materials and/or backfill layers may be used in other embodiments.

These foregoing embodiments depicted in FIGS. 1A-2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

FIG. 3 depicts an imaging system component 300 in cross-section that may be used with an imaging system incorporated into an electronic device, such as described herein. In one example, the imaging system component 300 is an electrically-controllable aperture having two or more switchable regions that may be positioned between an image sensor and a lens group defining a camera module incorporated into a portable electronic device such as a cellular phone.

In this example embodiment, the imaging system component 300 is configured to be positioned relative to an image sensor 302 so that the imaging system component 300 can effectively control a quantity of light exposed to the image sensor 302. More specifically, an electrochromic aperture 304 can be aligned parallel to an imaging surface of the image sensor 302.

A geometric center of the electrochromic aperture 304 may be aligned with a geometric center of the imaging surface of the image sensor 302. Relative positioning between the electrochromic aperture 304 and the image sensor 304 may vary from embodiment to embodiment.

The electrochromic aperture 304 can be electrically and conductively coupled to an aperture controller 306 configured to apply at least a threshold voltage to the electrochromic aperture 304 to change opacity (transmittance) of a switching region and/or more than one switching region of the electrochromic aperture 304 to change an effective transparent radius of the electrochromic aperture 304, thereby changing a quantity of light exposed to the image sensor 302.

The electrochromic aperture 304 includes a base substrate 308 that may be formed from glass. In some cases, the base substrate 308 is formed from silica, although this is merely one example.

The base substrate 308 of the electrochromic aperture 304 can have disposed on one or more external surfaces thereof an antireflective coating, such as an antireflective coating 310. In some cases, the antireflective coating 310 may be disposed onto a surface of the base substrate 308 by sputtering or another physical vapor deposition process. In other cases, the antireflective coating 310 may be adhered to the substate 308 with an adhesive. In yet other examples, the antireflective coating 310 may be disposed into the base substrate 308 as a liquid which is thereafter cured. In further examples, more antireflective coatings or layers can be added or positioned elsewhere in order to minimize reflections within the stack. It may be appreciated that these examples are not exhaustive; a person of skill in the art may readily appreciated that many suitable methods of disposing an antireflective coating may be used.

A first transparent conductor 312 may be disposed on a surface of the substrate opposite the antireflective coating 310. The first transparent conductor 312 can be formed from any number of suitable conductive transparent materials such as, and including, indium tin oxide or other conductive metal oxides. The first transparent conductor 312 can be disposed onto a surface of the base substrate 308 via any suitable method including physical vapor deposition.

An electrochromic stack 314 can be disposed over the first transparent conductor 312. The electrochromic stack 314 can be implemented in a number of ways.

The electrochromic stack 314 can include multiple discrete functional layers that cooperatively leverage electrochromic properties to define an electrically-controllable aperture, such as described herein. In particular, the electrochromic stack 314 can include a counter electrode, an ion conductor layer, and a layer of electrochromic material. The counter electrode can include a transition metal oxide, such as tungsten oxide or niobium oxide. In many cases, the counter electrode can be lithiated using a suitable process. The ion conductor layer can be any suitable material that permits movement of ions, such as lithium ions, but does not permit direct movement of electrons. In other words, the ion conductor layer is electrically insulating. The electrochromic layer can be any suitable electrochromic material, such as tungsten oxide or niobium oxide.

A second transparent conductor 316 may be formed over the electrochromic stack 314. The second transparent conductor 316 can be formed from the same material as the first transparent conductor 312, although this is not required of all embodiments.

The second transparent conductor 316 and the first transparent conductor 312 are disposed in a conductively decoupled manner such that when a voltage is applied across the conductors, a corresponding electric field can induce an electrochromic effect in the electrochromic stack 314. In particular, the first transparent conductor 312 can be conductively coupled to a first electrode 318 (which may be defined in part through the base substrate 308) and the second transparent conductor 316 can be conductively coupled to a second electrode 320 (which, like the first electrode 318, may be defined in part through the base substrate 308, e.g., as a through-glass via). As a result of this construction, the aperture controller 306 can be conductively coupled to the first and second electrodes in order to control electrochromic state(s) of the electrochromic stack 314.

In this example embodiment, the first transparent conductor 312 or the second transparent conductor 316 may be laser etched (or etched in another manner) to conductively decouple at least three portions thereof. By decoupling these portions, a central region 322 and an outer region 324 can be defined. The outer region 320 can be further subdivided to define multiple concentric rings; the concentric rings can be independent coupled to the aperture controller 306, for example by other (not shown) electrodes, vias, traces, or other conductive transparent conductive payers. As a result of this construction, an application of voltage to the by the aperture controller 306 may generate an electric field in one or more switched regions, thereby only inducing an electrochromic effect in those switched regions.

In some cases, the second transparent conductor 316 can be encapsulated by a second substrate, such as an upper substrate 326, which may also be formed from silica. The second transparent conductor 316 can be adhered to the upper substrate 326 by an adhesive layer (not labeled in FIG. 3). In some cases, another antireflective coating can be disposed onto the upper substrate 326. In FIG. 3, the antireflective coating 328 is shown.

These foregoing embodiments depicted in FIG. 3 and the various alternatives thereof and variations thereto are presented, generally, for purposes of explanation, and to facilitate an understanding of various configurations and constructions of an imaging system component, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, as noted above, more than one switching region can be defined in many embodiments. For example, multiple concentric rings of switching areas may be defined and may be individually addressable to the aperture controller 306. In these examples, the aperture controller 306 can selectively apply appropriate voltage to each additional ring so as to effectively change a radius (or other dimension or shape) of a transparent portion or an opaque portion of the electrochromic aperture 304.

In some examples, binary switching from fully transparent to fully opaque may not be required; in some cases, partial transparency may be achieved by applying a different voltage to the electrochromic aperture 304 (e.g., a gaussian aperture). In other cases, a sheet resistance of one or more of the conductive rings may be reduced so that a voltage drop across the sheet induces a linearly (radially) reducing electric field which, in turn, induces a more gradual change in transparency. In this example, the increased sheet resistance conductive ring can define a gaussian aperture.

Further, in some cases, one or more of the layers of the electrochromic stack may not necessarily be formed onto the base substrate 308 directly. In some cases, the electrochromic aperture 304 can be adhered to a portion of the base substrate 308, for example by an optically clear adhesive 328. In some embodiments, the optically clear adhesive 328 may have substantially the same index of refraction as antireflective layers and the base substrate, although this may not be required of all embodiments.

In some examples, the channel may be wider and/or may have another shape than shown in FIG. 3. For example, the channel may have any suitable width or depth. In some examples, the channel may extend, at least partially, into either the base substrate 308 and/or the second transparent conductor 316.

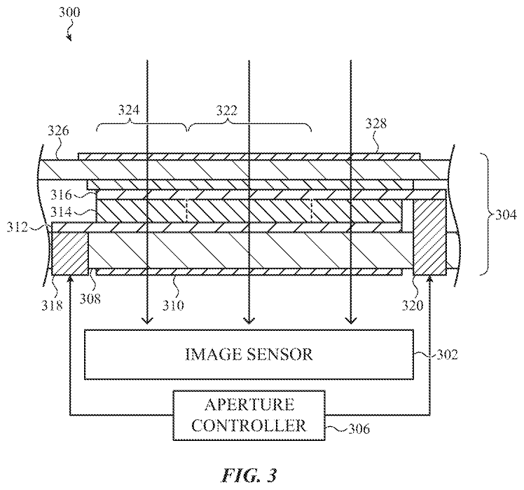

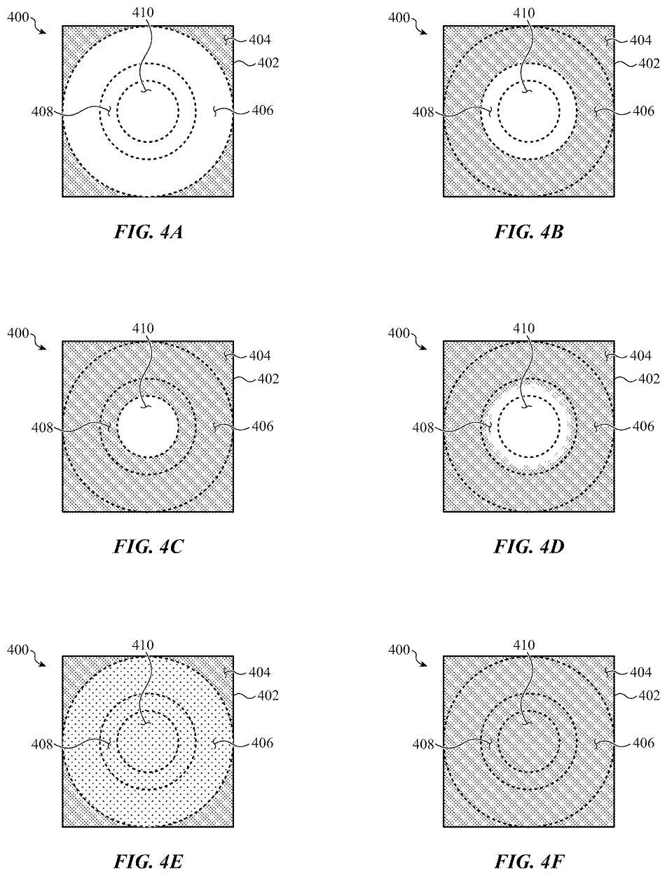

In typical constructions, however, it may be appreciated that multiple switching regions can be defined and independently controlled to change effective aperture. For example, FIG. 4A depicts a top view of an electrically-controllable aperture as described herein. The aperture 400 can be defined on a substate, such as the base substrate of FIG. 3. The aperture includes at least two switchable regions that may be defined by inner and outer electrodes circumscribing a central region, such as described above.

In particular, the aperture 400 includes a base substrate 402 onto which an opaque mast 404 may be defined. The opaque mask 404 may be formed from ink or another opaque material. In some cases, the opaque mask 404 may be omitted; it may not be required of all embodiments.

In the illustrated embodiment, the opaque mask 404 defines a circular area. Circumscribed by the opaque mask 404 may be an outer switchable region 406. In turn circumscribed by the outer switchable region 406 may be an inner switchable region 408, which in turn circumscribes a central region 410. The central region 410 may be switchable or non-switchable in different embodiments.

As a result of this construction, the aperture 400 can be selectively controlled to exhibit different geometries or, more generally, different radiuses of transparent region. For example, FIG. 4A depicts a configuration in which the outer switchable region 406 is in a bleached state and the inner switchable region 408 is in a bleached state and the central region 410 is in a bleached state. In this example, the aperture 400 has a transparent central region defined by the cumulative areas of the central region 410, the inner switchable region 408, and the outer switchable region 406. This configuration may permit a maximum amount of light to pass through the aperture 400 and illuminate an image sensor and may be suitable for use in low-light environments.

For another mode of operation, FIG. 4B depicts a configuration in which the outer switchable region 406 is in a colored state and the inner switchable region 408 is in a bleached state and the central region 410 is in a bleached state. In this example, the aperture 400 has a transparent central region defined by the cumulative areas of the central region 410 and the inner switchable region 408. This configuration may permit less light than the configuration shown in FIG. 4A to pass through the aperture 400 and illuminate an image sensor; this configuration may be suitable for use in brighter environments than the configuration of FIG. 4A.

For another mode of operation, FIG. 4C depicts a configuration in which the outer switchable region 406 is in a colored state and the inner switchable region 408 is in a colored state and the central region 410 is in a bleached state. In this example, the aperture 400 has a transparent central region defined only by the area of the central region 410. This configuration may permit a minimum amount of light to pass through the aperture 400 and illuminate an image sensor; this configuration may be suitable for use in very bright environments.

For another mode of operation, FIG. 4D depicts a configuration in which the outer switchable region 406 is in a colored state and the inner switchable region 408 is in a graduated colored state and the central region 410 is in a bleached state. In this example, the aperture 400 has a transparent central region primarily by the area of the central region 410 and partially by the inner switchable region 408. This configuration may define a gaussian aperture, which may exhibit improved imaging performance in comparison to the configuration of FIG. 4C in certain environments.

For another mode of operation, FIG. 4D depicts a configuration in which the outer switchable region 406 is in a partially colored state and the inner switchable region 408 is in a partially colored state and the central region 410 is in a partially colored state. In this example, the aperture 400 has a partially transparent central region defined by the cumulative areas of the central region 410, the inner switchable region 408 and the outer switchable region 410. This configuration may define a neutral density filter, which may exhibit improved imaging performance in certain environments.

For another mode of operation, FIG. 4E depicts a configuration in which the outer switchable region 406 is in a colored state and the inner switchable region 408 is in a colored state and the central region 410 is in a colored state. In this example, the aperture 400 is substantially opaque and does not permit light to pass in significant quantity therethrough. This configuration may define a shutter or camera cover, which may offer protection to an image sensor when that image sensor is not in use.

These foregoing embodiments depicted in FIG. 3 and the various alternatives thereof and variations thereto are presented, generally, for purposes of explanation, and to facilitate an understanding of various configurations and constructions of an electrically controllable aperture, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

These foregoing embodiments depicted in FIGS. 4A-4F and the various alternatives thereof and variations thereto are presented, generally, for purposes of explanation, and to facilitate an understanding of various configurations and constructions of an aperture, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

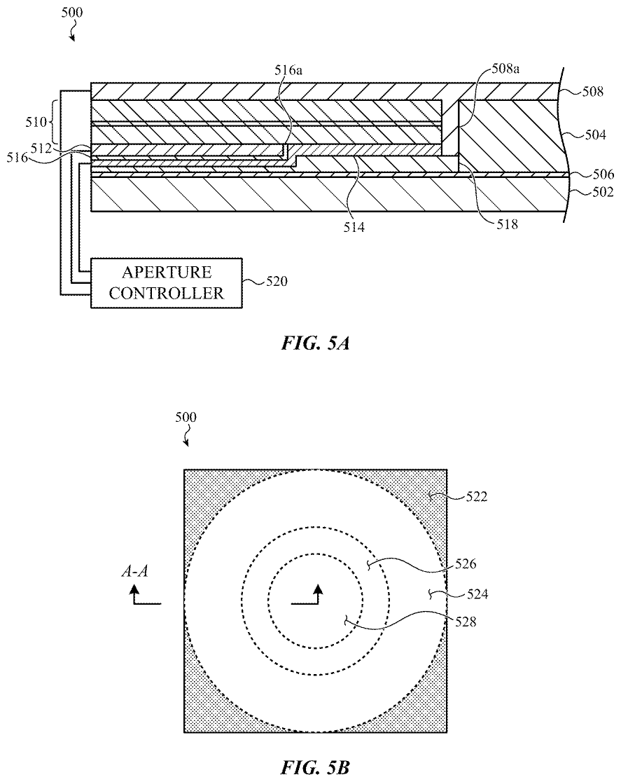

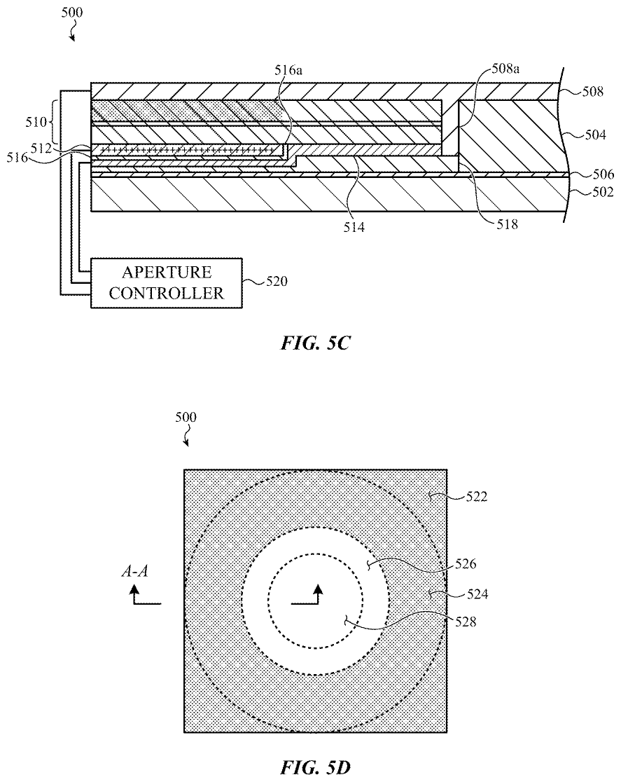

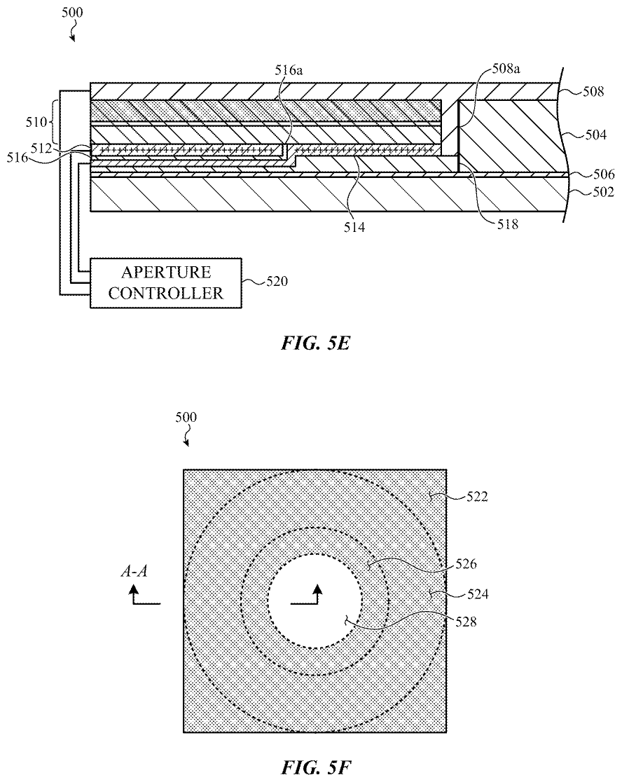

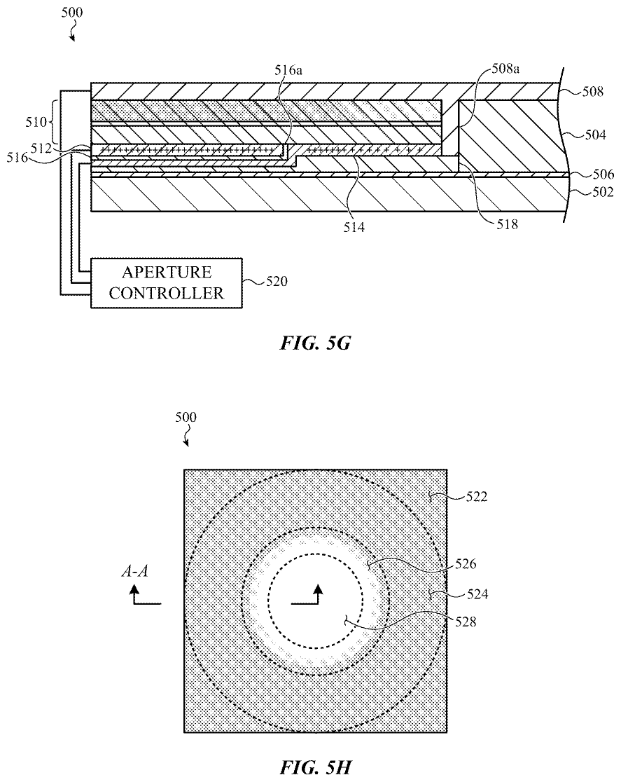

FIG. 5A depicts a partial cross-section of an electronically-controllable aperture as described herein. In particular, the electrically-controllable electrochromic aperture 500 depicted in FIG. 5A may be understood as taken through the line A-A of FIG. 5B, which depicts a top view of the electrically-controllable electrochromic aperture 500, when operated in a maximum aperture mode.

The electrically-controllable electrochromic aperture 500 shown in FIG. 5A may be formed over a platen or substrate formed from glass (e.g., silica). The substrate is identified in the figure as the base substrate 502.

As with other embodiments described herein the base substrate 502 can be formed form any number of suitable materials, but in many embodiments is formed from an optically transparent material. In some cases, the base substrate 502 may be formed from plastic or acrylic. In other cases, the base substrate 502 may not be a monolithic element and may be formed from a number of layers of different or similar materials. These foregoing examples are not exhaustive; a base substrate, such as the base substrate 502 can be formed in any number of suitable ways.

Over the base substrate 502 may be disposed a dielectric plug 504 that defines a central, non-switching, region of the electrically-controllable electrochromic aperture 500. The dielectric plug 504 can be formed from any number of suitable non-conductive materials that exhibit optical transparency (or are otherwise substantially transparent).

In addition, over the base substrate 502 may be disposed (optionally) an antireflective layer 506. As with other antireflective layers described herein, the antireflective layer 506 can be sputtered over the base substrate 502 or may be disposed by leveraging another suitable method. The antireflective layer 506 may be configured to reflect or absorb one or more bands of light (e.g., infrared, ultraviolet, and so on) and may be configured for transparency to other bands of light, such as visible light. In many embodiments, the antireflective layer 506 may be configured to reflect infrared light and to pass visible light, although it may be appreciated that this is merely one example embodiment and that in certain implementations, other bands of light may be reflected or, alternatively, absorbed by the antireflective layer 506.

The electrically-controllable electrochromic aperture 500 can include several electrodes, as noted with respect other aperture embodiments described herein. In particular, the electrically-controllable electrochromic aperture 500 can include a shared electrode 508 that extends across a substantial entirety of the electrically-controllable electrochromic aperture 500, in the illustrated embodiment. In particular, in the illustrated embodiment, the shared electrode 508 extends over the dielectric plug 504. As a result of this construction, light incident to the electrically-controllable electrochromic aperture 500 may pass through substantially the same path length and indices of refraction regardless whether that light is directed toward the central region (e.g., the dielectric plug 504 or elsewhere.

In other cases, the shared electrode 508 may not extend over the dielectric plug 506; in such embodiments, the shared electrode 508 may be defined as a ring electrode providing a conductive surface across the electrically-controllable electrochromic aperture 500 over all but an area above the dielectric plug 506.

The shared electrode 508 may be disposed over an electrochromic stack 510. As with other embodiments described herein, the electrochromic stack 510 can include multiple discrete layers, such as a counter electrode, an ion conductor layer, and an electrochromic material layer. It may be appreciated by a person of skill in the art that an electrochromic stack 510 can be formed in a number of suitable ways.

The electrochromic stack 510 may be positioned between the shared electrode 508 and a layer defining multiple ring electrodes, concentrically aligned. For example, the layer can include an outer ring electrode 512 concentrically surrounding (e.g., circumscribing) an inner ring electrode 514.

The outer ring electrode 512 and the inner ring electrode 514 can be conductively decoupled and physically separated (to a minimal degree) by a vertical portion of the dielectric layer 516, identified in FIG. 5A as the dielectric ring 516a. The dielectric layer 516 can be formed from any suitable dielectric material. The dielectric ring 516a may have a width selected to minimize a distance between the inner ring electrode 514 and the outer ring electrode 516; material selection of the dielectric layer 516 (and, correspondingly the dielectric ring 516a) may depend at least in part on a breakdown voltage thereof.

In many embodiments, the dielectric ring 516a and the dielectric layer 516 may be formed in the same operation from the same material, but this is not required of all embodiments. In particular, in some examples, the dielectric ring 516a may be formed from a first dielectric material and the dielectric layer 516 may be formed from a second dielectric material. In other embodiments, the dielectric ring 516a and the dielectric layer can be formed in subsequent (or otherwise different) processes.

The inner ring electrode 514 and the dielectric layer 516 cooperatively define a stair-step profile such that a portion of a radius of the inner ring electrode 514 is coplanar with the outer ring electrode 512 and a second portion of the inner ring electrode 514 is below the outer ring electrode 512, separated from the outer ring electrode 512 by the dielectric layer 516.

Thickness of the dielectric layer 516 may vary from embodiment to embodiment. In some cases, a thickness of the dielectric layer 516 may be uniform, whereas in other embodiments, a thickness of the dielectric layer 516 may vary radially or in another pattern.

The inner ring electrode 514 may be disposed over a stepped dielectric layer 518 that, in turn, is disposed and/or formed over the antireflective layer 506 or, for embodiments omitting the antireflective layer 506, the base substrate 502.

In many embodiments, including the illustrated embodiment, the shared electrode 508 can be conductively coupled to the inner ring electrode 514 via an extension portion 508a. As a result of this construction, the shared electrode 508 and the inner ring electrode 514 from a closed circuit, which can leverage a voltage drop across the inner ring electrode 514 to generate a radius-dependent electric field (between the shared electrode 508 and the inner ring electrode) that, in turn, differently influences opacity/coloring transitions through the electrochromic stack 510. In a more simple phrasing, the larger the voltage drop across the inner ring electrode 514, the lower the magnitude of a gradient in opacity change. A higher sheet resistance of the inner ring electrode 514 can correspond to a smoother change from substantially opaque to substantially transparent along a radius of the inner ring electrode 514. In other cases, a low sheet resistance of the inner ring electrode 514 can result in a fast falloff from substantially colored (or bleached) to substantially bleached (or colored).

In a more simple phrasing, generally and broadly, sheet resistance of the inner ring electrode 514 can define, at least in part, a gaussian mode of operation for the electrically-controllable electrochromic aperture 500.

Sheet resistance of the inner ring electrode 514 can be controlled in a number of ways. For example, a thickness of the inner ring electrode 514 can be varied. In other cases, the inner ring electrode 514 can be doped with a material that reduces conductivity. Examples include argon, germanium, phosphorous, zirconium, and strontium.

In some examples, the extension portion 508a may not be required.

As a result of this construction, the electrically-controllable electrochromic aperture 500 can be conductively coupled to an aperture controller, such the aperture controller 520. As with other embodiments described herein, the aperture controller 520 can be configured to apply implementation specific voltage to one or more of the inner ring electrodes 514, the outer ring electrode 512, and/or or the shared electrode 508.

For example, in a first mode of operation, the aperture controller 520 may be configured to not apply voltage to (and/or may be configured to ground to a system ground) the inner ring electrode 514, the outer ring electrode 512, and/or the shared electrode 508. In many constructions, this mode of operation may cause the electrochromic stack 510 to enter, or to maintain, a bleached state.

In this mode of operation shown in FIG. 5B, the electrically-controllable electrochromic aperture 500 may permit a maximum quantity of light to pass.

The electrically-controllable electrochromic aperture 500 can include an opaque perimeter 522 that defines a circular interior region. The interior region, in this example, is transparent due, at least in part, to a particular application of voltage by the aperture controller 520 to the inner ring electrode 514 and the outer ring electrode 512.

The opaque perimeter 522 may be formed from an opaque ink layer, a metal layer, or may be formed from any other suitable non-transparent material.

The opaque perimeter 522 surrounds an outer switchable region 524 defined by the outer ring electrode 512. In other words, when the outer ring electrode 512 is driven to a particular voltage, a portion of the electrochromic stack 510 positioned between the outer ring electrode 512 and the shared electrode 508 may transition from a bleached state (such as shown in FIG. 5B) to a colored state.

The outer switchable region 524 surrounds an inner switchable region 526 defined by the inner ring electrode 514. In other words, when the inner ring electrode 514 is driven to a particular voltage, a portion of the electrochromic stack 510 positioned between the inner ring electrode 514 and the shared electrode 508 may transition from a bleached state (such as shown in FIG. 5B) to a colored state.

The electrically-controllable electrochromic aperture 500 may also include a central, non-switching region, identified as the non-switching region 528.

As a result of this construction, the electrically-controllable electrochromic aperture 500 can be leveraged by the aperture controller 520 to change its effective transparent diameter. For example, FIGS. 5C-5D depict an operational mode of the electrically-controllable electrochromic aperture 500 in which the aperture controller 520 applies a voltage to the outer ring electrode 512, thereby inducing an electrochromic shift from bleached to colored in a portion of the electrochromic stack 510 between the outer ring electrode 512 and the shared electrode 508.

In another mode of operation, such as shown in FIGS. 5E-5F, the aperture controller 520 applies a voltage to the outer ring electrode 512 and to the inner ring electrode 514, thereby inducing an electrochromic shift from bleached to colored in portions of the electrochromic stack 510 between the outer ring electrode 512 and the shared electrode 508 and in portions of the electrochromic stack 510 between the inner ring electrode 512 and the shared electrode 508.

In yet another mode of operation, such as shown in FIGS. 5G-5H, the aperture controller 520 applies a voltage to the outer ring electrode 512 and to the inner ring electrode 514, thereby inducing an electrochromic shift from bleached to colored in portions of the electrochromic stack 510 between the outer ring electrode 512 and the shared electrode 508 and in portions of the electrochromic stack 510 between the inner ring electrode 512 and the shared electrode 508. However, in this embodiment, the inner ring electrode 514 exhibits a sheet resistance that causes a progressive drop in voltage across a width thereof. As a result, the induced electrochromic effect within the portion of the electrochromic stack 510 between the shared electrode 508 and the first ring electrode 514 may gradually change from substantially opaque to substantially transparent. In this embodiment, the electrically-controllable electrochromic aperture 500 may be operated as a gaussian aperture.

These foregoing embodiments depicted in FIGS. 5A-5H and the various alternatives thereof and variations thereto are presented, generally, for purposes of explanation, and to facilitate an understanding of various configurations and constructions of an electrically-controllable electrochromic aperture 500, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in some embodiments the inner ring electrode may not be conductively coupled to the shared electrode. In such examples, the inner ring electrode may be coupled to the aperture controller only.

In other cases, it may be appreciated that multiple additional switchable regions can be defined; implementations of embodiments described herein are not limited to merely two switchable regions.

Further, it may be appreciated that in some examples, a central region of an electrically-controllable electrochromic aperture may define another switchable region. In other words, an electrochromic layer, and/or one or more electrodes such as the shared electrode and/or an inner ring electrode, may extend across and/or through the dielectric plug of FIG. 5A. In these examples, the central region of the electrically-controllable electrochromic aperture 500 may be switched from a bleached state to a colored state or any suitable transparency or opacity therebetween.

In yet other examples, an inner ring may be operated in an opaque or partially opaque mode while all other regions (including a central imaging aperture and outer rings) are transparent. Such configurations may create unique imaging effects. More broadly, it may be appreciated that the independently-controllable aperture rings may not necessarily be activated or used in sequence.

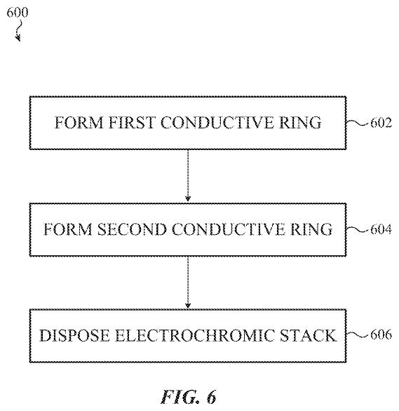

FIG. 6 depicts example operations of a method of manufacturing an electrically-controllable electrochromic aperture as described herein. The method 600 includes operation 602 in which a first conductive ring (such as an inner conductive ring or an outer conductive ring, as described above) may be disposed and/or formed onto a base substrate such as glass. The method 600 further includes operation 604 at which a second conductive ring may be formed. Over the first and second conductive rings, which are conductively decoupled from one another, an electrochromic stack can be formed at operation 606.

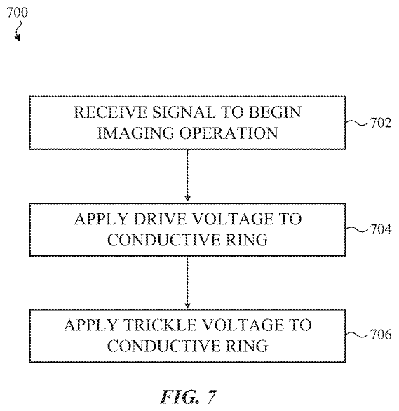

FIG. 7 depicts example operations of a method of operating an electrically-controllable electrochromic aperture as described herein. The method 700 includes operation 702 in which a signal is received (e.g., at an aperture controller) to initiate an imaging operation. Next, at operation 704, a voltage such as a drive voltage may be applied to a conductive ring of the electrically-controllable electrochromic aperture, such as an inner ring electrode or an outer ring electrode. The voltage may be configured to induce a transition from a colored state to a bleached state or, in the alternative, a transition from a bleached state to a colored state.

The method 700 also includes operation 706 at which a maintenance voltage may be applied to the electrically-controllable electrochromic aperture so as to maintain the current transparency state thereof.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A multistep electrochromic aperture comprising:
a substrate;
a first ring electrode disposed over the substrate to a first diameter;
a dielectric ring disposed over the first ring electrode;
a second ring electrode disposed over the dielectric ring and conductively decoupled from the first ring electrode;
a third ring electrode disposed within, and circumscribed by, the second ring electrode, the third ring electrode disposed to a second diameter less than the first diameter and the third ring electrode conductively coupled to the first ring electrode by a via extending along at least a thickness of the dielectric ring;
an electrochromic counter electrode disposed over the second ring electrode and the third ring electrode;
an electrochromic ion conductor layer disposed over the electrochromic counter electrode;
an electrochromic layer disposed over the ion conductor layer; and
a shared upper electrode disposed over the electrochromic layer.

2. The multistep electrochromic aperture of claim 1, wherein the first ring electrode is centered with a geometric enter of the substrate.

3. The multistep electrochromic aperture of claim 1, comprising a dielectric buffer disposed between the second ring electrode and the third ring electrode conductively decoupling the second ring electrode and the third ring electrode.

4. The multistep electrochromic aperture of claim 3, wherein the electrochromic counter electrode is disposed over the dielectric buffer.

5. The multistep electrochromic aperture of claim 1, wherein the first ring electrode, the second ring electrode and the third ring electrode are members of a set of electrodes comprising four or more ring electrodes.

6. The multistep electrochromic aperture of claim 1, wherein the first ring electrode has a circular shape.

7. The multistep electrochromic aperture of claim 1, wherein the first ring electrode, the second ring electrode, and the third ring electrode are concentrically aligned.

8. The multistep electrochromic aperture of claim 1, wherein the substrate comprises glass.

9. A multistep electrochromic aperture comprising:
a substrate comprising a central region formed from a transparent material;
a lower outer ring electrode disposed to a first diameter;
a dielectric ring disposed over the lower outer ring electrode;
an upper outer ring electrode disposed over the dielectric ring and conductively decoupled from the lower outer ring electrode;
an inner ring electrode disposed within, and circumscribed by, the upper outer ring electrode, the inner ring electrode conductively coupled to the lower outer ring electrode and coplanar with the upper outer ring electrode;
an electrochromic stack disposed over the upper outer ring electrode and the inner ring electrode, the electrochromic stack comprising:
an electrochromic counter electrode;
an electrochromic ion conductor layer disposed over the electrochromic counter electrode; and
an electrochromic material layer disposed over the ion conductor layer; and
a common electrode disposed over the electrochromic layer.

10. The multistep electrochromic aperture of claim 9, wherein the lower outer ring electrode is segmented.

11. The multistep electrochromic aperture of claim 9, wherein the electrochromic layer selectively bleaches in response to voltage applied to the lower outer ring electrode or the upper outer ring electrode.

12. The multistep electrochromic aperture of claim 9, wherein a first sheet resistance of the lower outer ring electrode is different from a second sheet resistance of the upper outer ring electrode.

13. The multistep electrochromic aperture of claim 9, wherein the shared electrode extends over a substantial majority of the substrate.

14. The multistep electrochromic aperture of claim 9, wherein the lower outer ring electrode and the inner ring electrode are integrally formed.

15. The multistep electrochromic aperture of claim 9, further comprising an opaque mask circumscribing the upper outer ring electrode.

16. An electronic device comprising:
a housing;
a camera module extending at least partially through the housing; and
an electrochromic aperture disposed over an imaging sensor of the camera module, the electrochromic aperture comprising:
a lower outer ring electrode disposed to a first diameter;
a dielectric ring disposed over the lower outer ring electrode;
an upper outer ring electrode disposed over the dielectric ring and conductively decoupled from the lower outer ring electrode;
an inner ring electrode disposed within, and circumscribed by, the upper outer ring electrode, the inner ring electrode conductively coupled to the lower outer ring electrode and coplanar with the upper outer ring electrode;
an electrochromic stack disposed over the upper outer ring electrode and the inner ring electrode; and
a common electrode disposed over the electrochromic stack.

17. The electronic device of claim 16, wherein, in response to a signal from the electronic device, the electrochromic aperture is configured to apply a first voltage to the lower outer ring electrode to drive the inner ring electrode to a second voltage that colors or bleaches a portion of the electrochromic stack above the inner ring electrode.

18. The electronic device of claim 16, wherein, in response to a signal from the electronic device, the electrochromic aperture is configured to drive the upper outer ring electrode to a voltage that, in turn, colors or bleaches a portion of the electrochromic stack above the upper outer ring electrode.

19. The electronic device of claim 16, wherein the common electrode extends across a diameter of the upper outer ring electrode.

20. The electronic device of claim 16, wherein the lower outer ring electrode is aligned with a central axis of the imaging sensor.
